(19) United States
(12) Patent Application Publication
(10) Pub. No.: US 2004/0226409 A1
(43) Pub. Date: Nov. 18, 2004

(54) Level cork needle

(76) Inventor: Chia-Hsien Lin, Taipei (TW)

Correspondence Address: Chia-Hsien LIN, PO Box 82-144, Taipei, TW

(21) Appl. No.: 10/435,546

(22) Filed: May 12, 2003

(51) Int. Cl. B67B 7/00

(52) U.S. Cl. 81/3.2

(57) ABSTRACT

An improved structure of a level cork needle is comprised of a syringe, a plunger, a coolant flask, a needle lid and a cork; wherein, the needle being provided to the front of the syringe, the syringe being inserted into the plunger, the needle lid being screwed to the front of the syringe, the coolant flask being placed inside the syringe and exposed for a certain portion, and screwed to the tail of the syringe by the cock and the cock is threaded for easier grasp and slip-proof characterized by that a gap being provided on and through the cock to allow a finger to pass through to press the coolant flask for pumping pressurized gas into the bottle to push out the cork.

### BACKGROUND OF THE INVENTION

(a) Field of the Invention

The present invention is related to an improved structure of a level cork needle, and more particularly, to one that having provided a gap to press on top of the cock of the cork needle to hold the coolant flask inside the syringe in place for the user to directly press with his finger to press the bottom of the coolant flask to pump the pressured gas into the bottle to push out the cork.

(b) Description of the Prior Art:

The lid and the coolant flask of a level cork needle of the prior art must be separated when the cork needle is not used. Consequently, it is very easy to miss either or both when the occasion requires the cork needle rises.

### SUMMARY OF THE INVENTION

The primary purpose of the present invention is to provide an improved structure of a level cork needle by having a gap provided on top of the cock so to hold the coolant flask inside the syringe and to allow a finger to put in to press the bottom of the coolant flash to pump the pressurized gas into the bottle to push out the cork.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a view showing an appearance of the prior art.

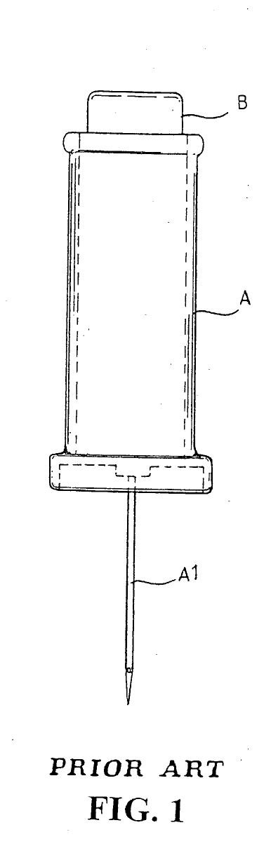

FIG. 2 is a view showing another prior art.

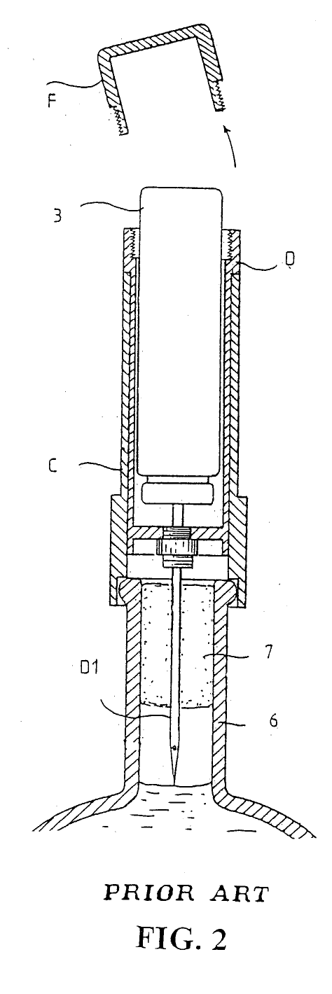

FIG. 3 is an explored view of a preferred embodiment of the present invention.

FIG. 4 is a schematic view showing that the preferred embodiment of the present invention is in use.

FIG. 5 is a view showing another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

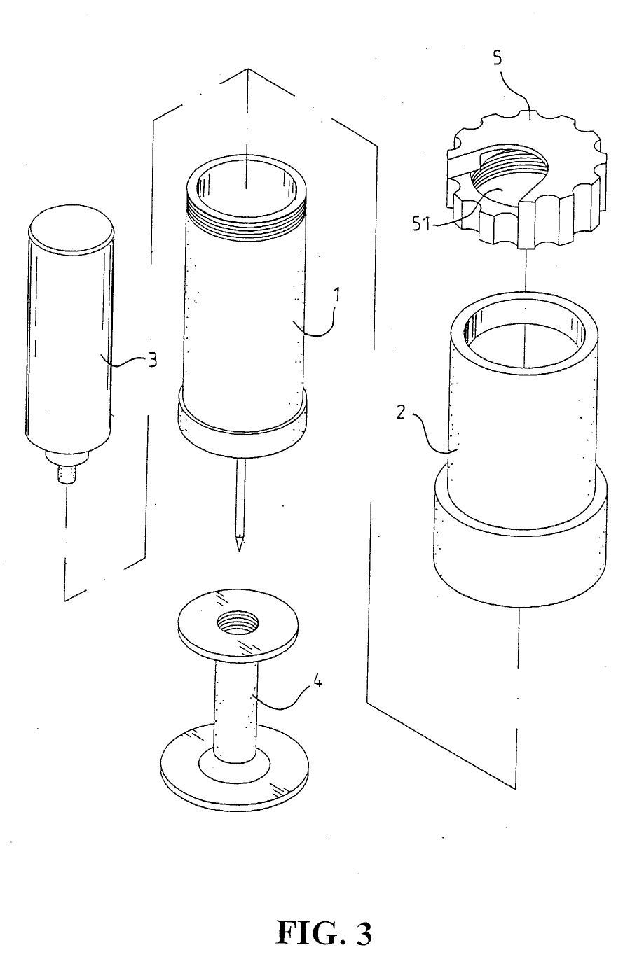

Referring to FIG. 3, a preferred embodiment of the present invention is essentially comprised of a syringe (1), a plunger (2), a coolant flask (3), a needle lid (4) and a cock (5). Wherein, a needle (11) is provided to the front of the syringe (1). The syringe (1) passes through the plunger (2) and both slide against each other. An interference configuration defined between the needle (11) and the plunger (2) prevents the plunger (2) from slipping off the needle (11). The needle lid (4) is screwed to the front end of the syringe (1) as protection. The coolant flask (3) is placed inside the syringe (1) and protrudes out of the syringe (1) for a certain portion. The coolant flask (3) is screwed to the tail of the syringe (1) with the cock (5) to be protected by the cock (5) so that the coolant flask (3) is merely placed inside the syringe (1). The cock (5) is made in a shape provided with threads for slip-proof and easier grasp. The present invention is characterized by that a gap (51) is provided on and penetrating through the top of the cock (5) in a size that allows a finger to pass through to press the coolant flask (3).

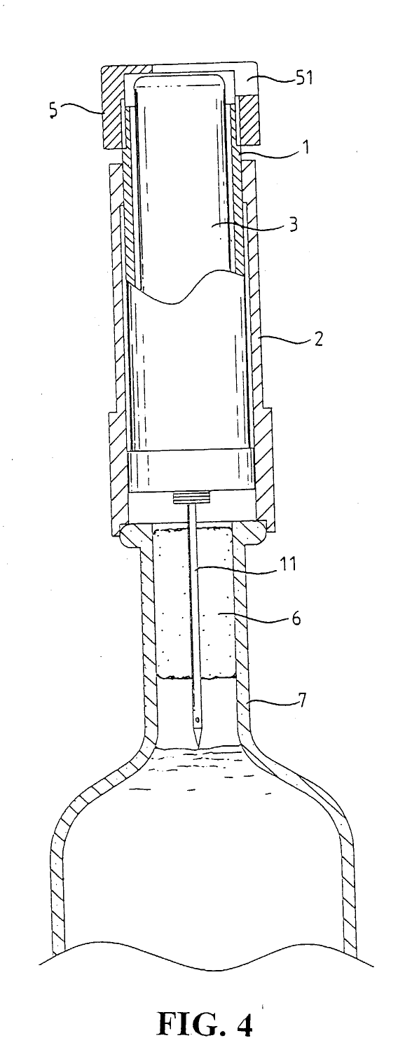

Now referred to FIG. 4, the plunger (2) caps on the opening of a bottle (6) with the needle (11) precisely falling on the center of the opening of the bottle (6) to prevent the needle (11) from being broken due to misalignment when the needle (11) is inserted into the cork. Upon making sure that the needle (11) is correctly positioned, the finger is putt through the gap (51) in the cock (5) to press the coolant flask (3) to pump pressured gas into the bottle (6) to push out the cork (7).

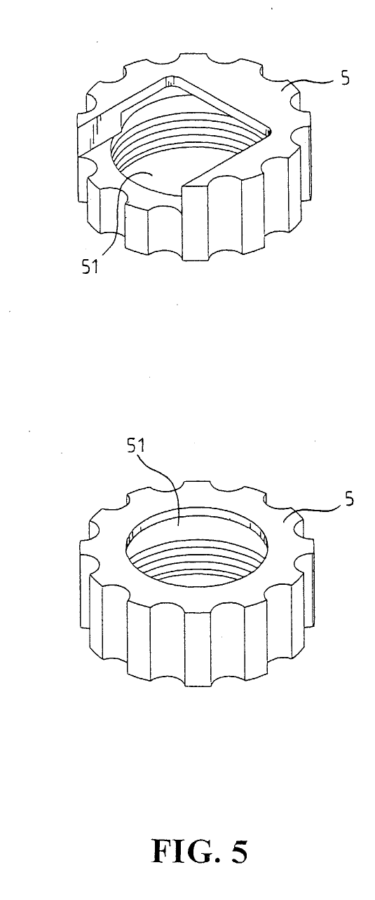

The gap (51) may be made in a square or a concentric circle as illustrated in FIG. 5 as long as it permits one finger to pass through.

Whether the present invention is in use or not, it is not necessary to remove the cock and the coolant flask remains staying inside the syringe without the risk of missing either or both.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a level cork needle comprising a syringe, a plunger, a coolant flask, a needle lid, and a cock, wherein a needle is provided to the front of the syringe, the syringe passing through the plunger to slide against each other, the plunger being restricted to the needle due to an interference configuration defined between the needle and the plunger; the needle lid being screwed to the front of the syringe as protection; the coolant flask being placed in the syringe and protruding out of the syringe for a certain portion; and the cock being screwed to the tail of the syringe for the cock to protect the syringe characterized by that a gap being provided on top and penetrating through the cock in a size allowing a finger to put into to press the coolant flask.
